(19) United States
(12) Patent Application Publication
(10) Pub. No.: US 2026/0160408 A1
(43) Pub. Date: Jun. 11, 2026

(54) MODULAR REUSEABLE LED LIGHTING APPARATUS AND SYSTEMS

(71) Applicant: Kale Lacroux, Carbondale, CO (US)

(72) Inventor: Kale Lacroux, Carbondale, CO (US)

(21) Appl. No.: 19/412,604

(22) Filed: Dec. 8, 2025

Related U.S. Application Data
(60) Provisional application No. 63/729,058, filed on Dec. 6, 2024.

(51) Int. Cl. F21V 23/00; F21S 4/28; F21V 27/00

(52) U.S. Cl. CPC F21V 23/001; F21S 4/28; F21V 27/00

(57) ABSTRACT

Reusable and modular LED lighting systems are provided. In some embodiments, the system comprises extendable lighting strips with connecting brackets and jumper cables. Installation kits and storage units are also provided. In some other embodiments, the LED lighting system is a modular system. With provided buckets and bases, and multiple lighting strips, the lighting systems can be converted to various configurations, including but not limited to stars, crowns, and flagpoles.

### CROSS REFERENCE

This U.S. Non-Provisional Patent Application claims benefit of U.S. Provisional Application No. 63/729,058, filed on Dec. 6, 2024, the entire disclosure of which is hereby incorporated by reference.

### FIELD OF THE INVENTION

The present disclosure generally relates to lighting apparatus and systems, and more specifically to low-voltage modular reusable LED lighting systems.

### BACKGROUND

Because of their durability, brightness, efficiency, and lifespan, Lighting Emitting Diode (LED) lighting systems and devices are widely used in various environments. For example, LED lighting systems are widely used in construction sites, convention centers, commercial facilities, and residential homes.

However, conventional LED lighting systems also have some drawbacks. Many users find LED lighting systems have relatively high initial and replacement costs. LED lights also tend to be extremely sensitive to voltage, which results in unstable brightness and performance. Furthermore, compatibility has been another drawback of the existing LED products as they can be found difficult to use with existing traditional controllers and dimmers.

### SUMMARY

There is a long-felt and unmet need for LED lighting systems that are economical, stable, and have high compatibility with traditional electric systems. There is also a long-felt and unmet need for LED lighting systems that are adjustable and adaptable to various scenarios and environments.

It is one aspect of various embodiments of the present disclosure to provide an LED lighting system that is affordable and cost-efficient. Some embodiments of the present disclosure comprise reusable components that can be installed and disassembled easily.

It is another aspect of various embodiments of the present disclosure to provide an LED lighting system that is suitable for use in various environments. Some embodiments of the present invention comprise waterproof components. Some embodiments of the present invention provide securing members (e.g. clips) to secure lighting strips on or from various surfaces. Some other embodiments of the present invention have a plurality of lighting strips that can be connected to each other creating an extended lighting strip with a desired length, arrangement, orientation, etc.

It is yet another aspect of various embodiments of the present disclosure to provide a customizable LED lighting system. Some embodiments of the present inventions comprise modular lighting systems that can be arranged in different shapes, arrangements, orientations, etc. including but not limited to stars, crowns, and flagpoles.

Another aspect of various embodiments of the present disclosure is to provide an LED lighting system that is portable, easy to store, and deployable in various settings and environments. Some embodiments of the present invention provide a case. Some embodiments of the present invention further provide a case with multiple internal compartments designated to store different components.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

As used herein and unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The embodiments and configurations described herein are neither complete nor exhaustive. As will be appreciated, other embodiments are possible utilizing, alone or in combination, one or more of the features set forth above or described in detail below.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of the invention.

FIG. 1 illustrates an overview of the lighting system in a pre-installation state.

FIGS. 2A-2C provide perspective, front, and right-perspective views of the exterior of a case of the embodiment of FIG. 1.

FIG. 2D illustrates a perspective view of the interior division of the case of the embodiment of FIG. 1.

FIGS. 3A-3B illustrate one or more strips connected to a power supply.

FIGS. 4A-4B provide the perspective front and left views of a power supply according to an embodiment of the present disclosure.

FIG. 5A provides multiple views of a cable according to an embodiment of the present disclosure.

FIG. 5B is a perspective view of a component of various embodiments of the present disclosure.

FIG. 5C is a perspective view of a component of various embodiments of the present disclosure.

FIG. 5D is a perspective view of a component of various embodiments of the present disclosure.

FIG. 5E is a perspective view of a component of various embodiments of the present disclosure.

FIGS. 6A-6D provide top, side, bottom, and sectional views of a component according to various embodiments of the present disclosure.

FIGS. 6E-6G provide various perspective views of a component according to various embodiments.

FIGS. 7A-7C provide a front, bottom, and top view of a clip according to various embodiments.

FIGS. 8A-8C illustrate a connecting component according to an embodiment of the present disclosure.

FIGS. 9A-9C illustrate a lighting element and associated components according to an embodiment of the present disclosure.

FIGS. 10A-10B illustrate a connecting component according to an embodiment of the present disclosure.

FIG. 10C is a perspective view of a connecting component according to an embodiment.

FIG. 11 illustrates a modular lighting system of one embodiment provided in a first configuration.

FIGS. 12A-12C illustrate a component of a lighting system according to one embodiment.

FIGS. 13A-13B illustrate a modular lighting system according to an embodiment of the present disclosure.

FIG. 14 illustrates a connection and converting mechanism of a plurality of brackets of the modular lighting system.

FIGS. 15A-15B illustrate a lighting system according to an embodiment of the present disclosure.

FIGS. 16A-B illustrates a lighting system according to an embodiment of the present disclosure.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure.

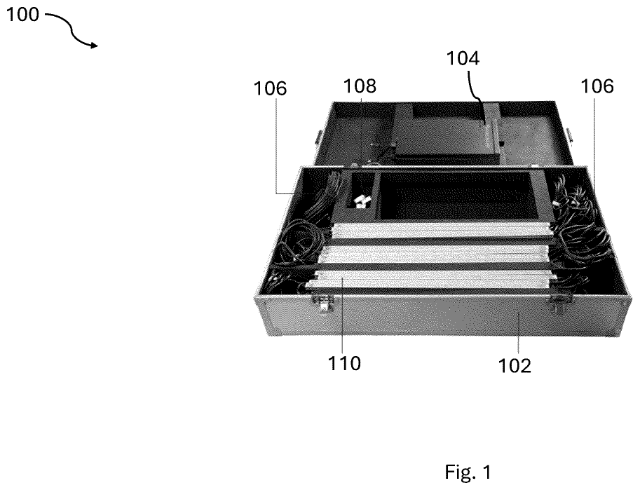

FIG. 1 illustrates a lighting system 100 in a pre-installation state. As shown in FIG. 1, the modular LED lighting system 100 comprises a case 102, a power supply 104, one or more cables 106, a plurality of clips 108, and light strings or strips 110. Specifically, the case 102 has one or more interior compartments 112. When the lighting system 100 is in a pre-installation state as shown in FIG. 1, the power supply 104, the one or more cables 106, the plurality of clips 108, and the light strings and strips 110 can all be fitted and secured into the one more designated interior compartments 112 of the case 102 to provide a portable system.

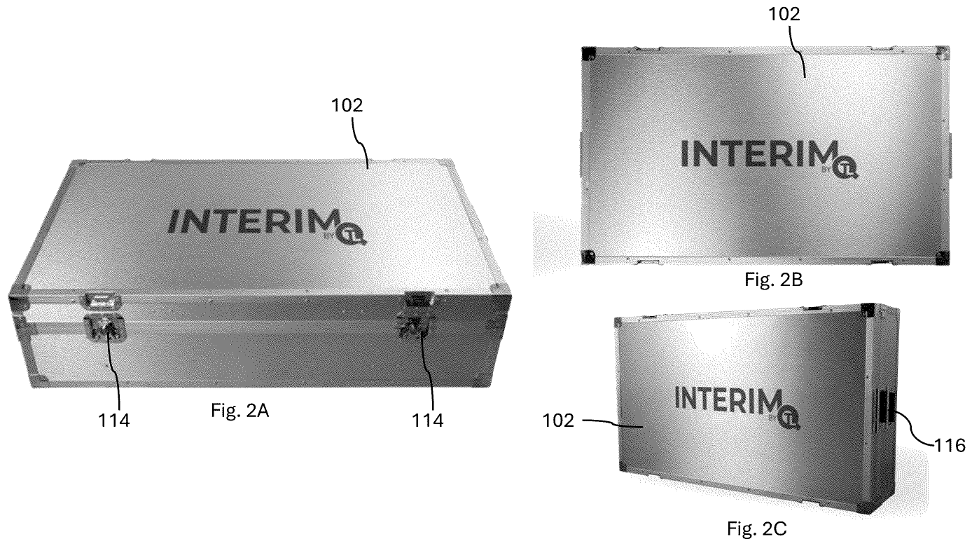

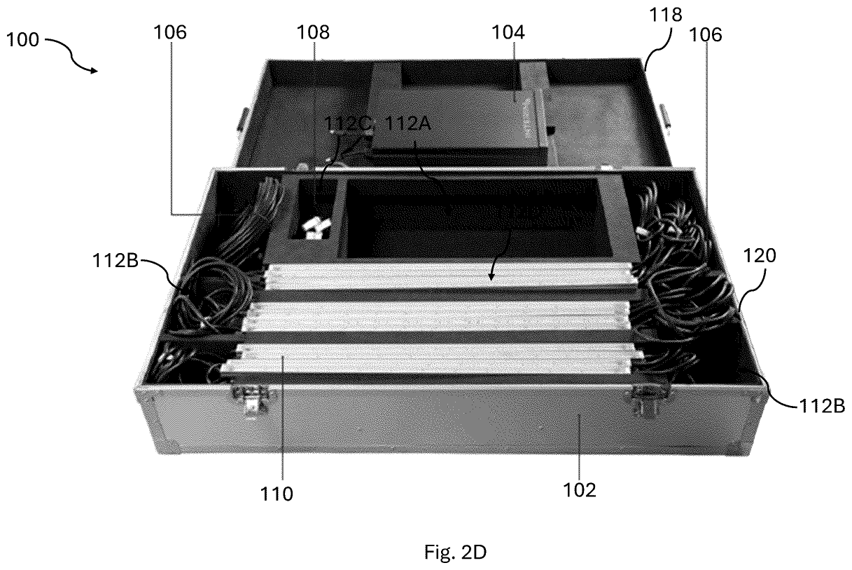

FIGS. 2A-2C provide perspective, front, and right-perspective views of the exterior of a case of the modular LED lighting system 100. In the non-limiting embodiment, the case 102 is constructed into a rectangular shape with aluminum. The case 102 has at least two locking mechanisms 114 (as shown in FIG. 2A) to ensure safety of the components contained therein. The case 102 further has one or more handles 116 to increase the portability of the lighting system 100. It will be appreciated that in some embodiments, the case may be constructed in other known 3D shapes. It is also appreciated that in yet other embodiments, the case may have any number of locking mechanisms and any number of handles.

FIG. 2D is a perspective view showing an interior of the case 102 of the modular LED lighting system 100. As described above, the case 102 has one or more interior compartments 112 designated to store different components of the lighting system 100. In the non-limiting embodiment, the case 102 has a top section 118 and a bottom section 120, where a height of the top section 118 is smaller than a height of the lower section 120. In the non-limiting embodiment, the bottom section 120 has a total of seven compartments 112, including a power supply compartment 112A, two cable compartments 112B, one clip compartment 112C, and three strip compartments 112D. It is appreciated that the dimensions, arrangements, and number of the compartments can vary in different embodiments.

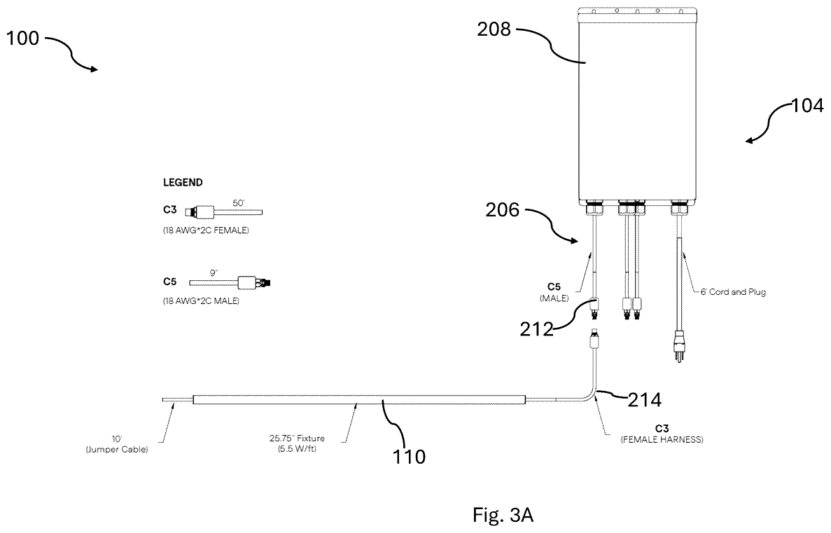

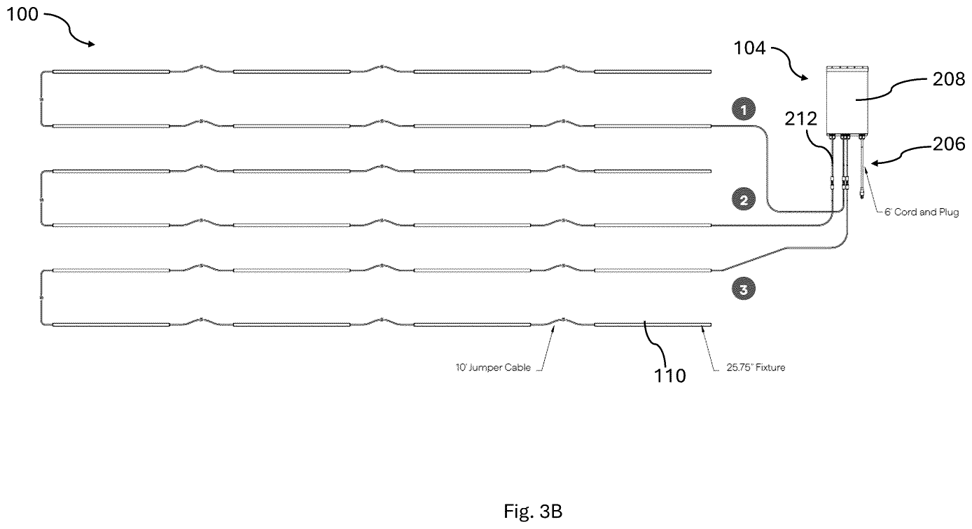

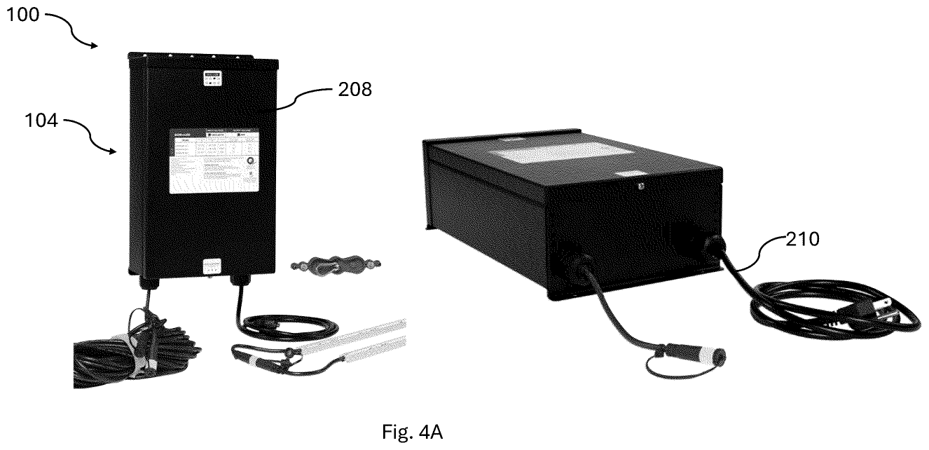

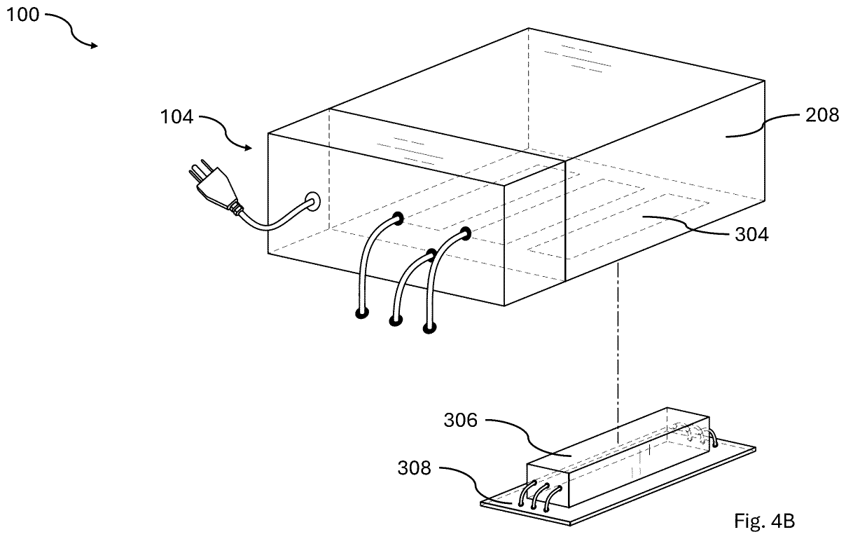

FIGS. 3A-3B illustrate a modular lighting system 100 with one or more lighting elements in the form of strips 110 connected or connectable to a power supply 104 or power enclosure, in accordance with one or more embodiments of the present disclosure. Specifically, the power supply 104 of the lighting system 100 has a wire compartment 206 and a power supply compartment 208. The wire compartment 206 includes a main plug 210 (as shown in FIG. 4A) constructed to be connected to a 120V outlet. The wire compartment further has a plurality of male quick connectors 212 configured to be connected with female harness 214, and the female harness 214 is configured to be connected to a fixture 110, for example, LED string or strips. As shown in FIG. 3B, in the non-limiting embodiment, the wire compartments 206 has three male quick connectors 212, where each of the male connectors 212 is connected to a female harness 214. It is appreciated that in some embodiments, the number of the male quick connector may vary. Furthermore, the fixture can be extended to a desired length by connecting multiple strings end-to-end with jumper cables between the elements.

FIGS. 4A-4B provide perspective views of a power supply 104 of the lighting system 100 according to an embodiment of the present disclosure. As shown in FIG. 4B, the power compartment 208 of the power supply 104 has one or more slots configured to receive LED drivers 306. The one or more slots 304 each has a mounting plate 308 with quick connect mechanism to the power enclosure. The drivers 306 may comprise, for example, 100 watt 24V DC constant current LED drivers. In some embodiments, the device comprises three slots 304 to receive one to three drivers to deliver a maximum output of 300 watts to LED lights. In some other embodiments, up to six slots 304 are provided to receive four to six drivers to deliver a maximum output of 600 watts to LED lights.

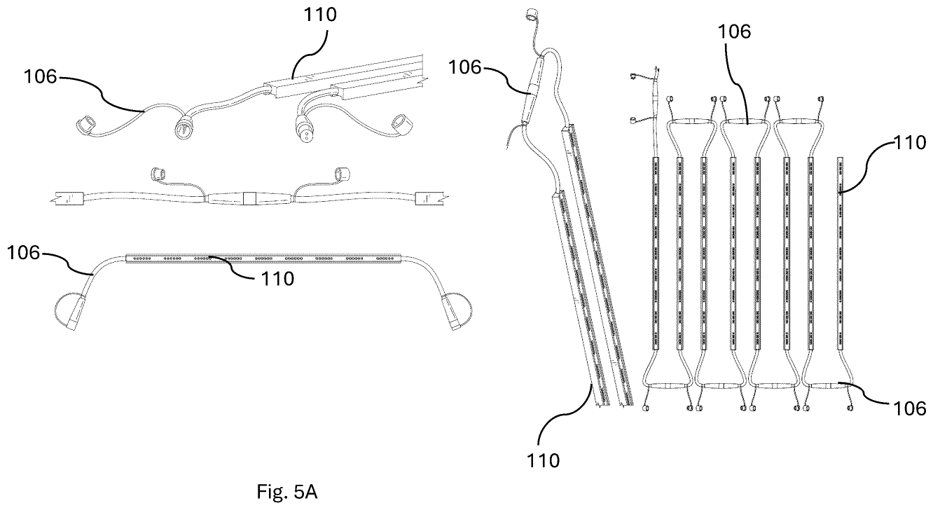

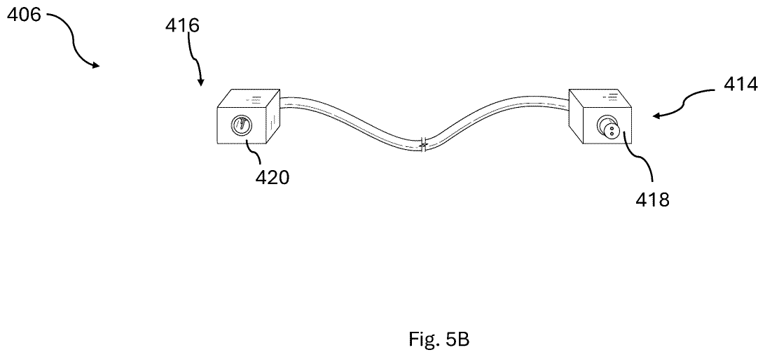

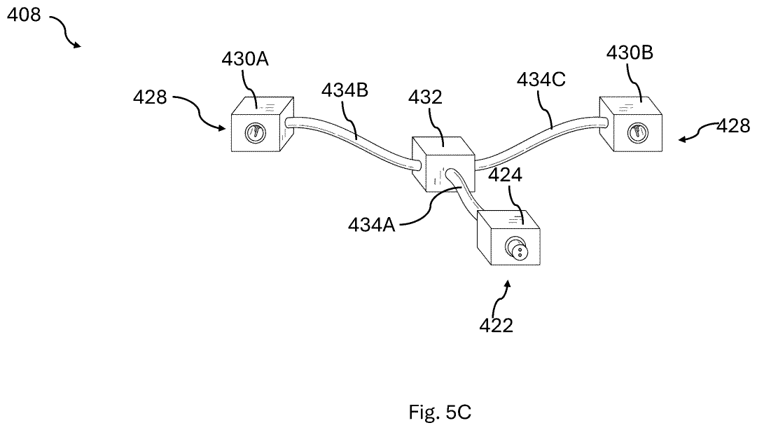

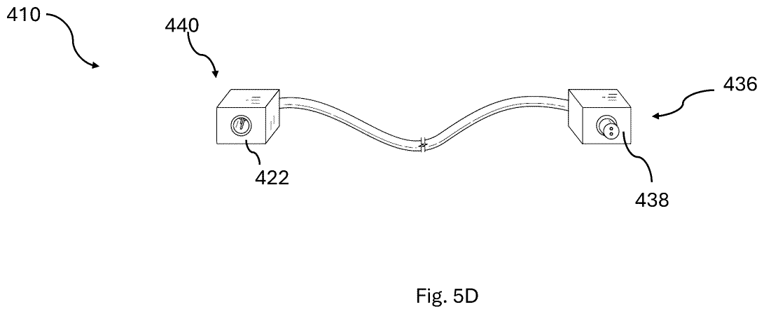

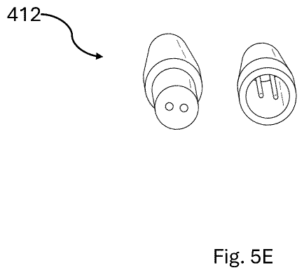

FIG. 5A provides multiple views of cables 106 and fixtures 110 (i.e., strings) of a lighting system 100. Specifically, each of the cables 106 has at least one leader cable 406, as shown in FIG. 5B (for example); an optional leader cable splitter 408, as shown in FIG. 5C; an optional jumper cable 410, as shown in FIG; 5D, and cable end caps 412, as shown in FIG. 5E.

FIG. 5B illustrates the leader cable 406 of the lighting system 100. In the non-limiting embodiment, the leader cable 406 has a first end 414 and a second end 416. The first end 414 has a female quick connector 418 configured to be connected to the power enclosure, and the second end 416 has a male quick connector 420. The leader cable 406 further has a cable wire 422 extends between the first and second ends 414 and 416. In the non-limiting embodiments, the leader cable 406 has a length of 50 feet. It is appreciated that length of the cable may vary in different embodiments. In the non-limiting embodiment, the male connector 420 is provided in a first color and the female connector 418 is provided in a second color. The different colors provide visual differences of the two ends, which helps installers to quickly identify the correct orientation of the leader cable.

FIG. 5C illustrates the leader cable splitter 408 of the lighting system 100. Specifically, the leader cable splitter 408 has a first end 422 with a female connector 424, which is constructed to be connected with the power enclosure or any one of the strips in the lighting system 100 to maximize versatility of the lighting system 100. The leader cable splitter 408 further has a second end 426 and a third end 428, and each of the second and third ends has a male connector 430. In the non-limiting embodiment, the leader cable splitter 408 further has a central connector 432 and three cable wires 434, where each one of the cable wires 434 extends between the central connector 432 and one of the first, second, or third ends 422, 426, and 428 of the leader cable splitter 408 forming a “T” shape. Specifically, the first cable wire 434A extends between the first end 422 and the central connector 430; the second cable wire 434B extends between the second end 426 and the central connector 430, and a third cable wire 434C extends between the third end 428 and the central connector 430 along an opposite orientation to the second wire, and the first wire is proximate perpendicular to the second and third wires. It is appreciated that in some embodiments, a leader cable splitter may or may not have a central connector. It is further appreciated that some embodiment may include cable wires and connectors arranged in different orientations and shapes. In the non-limiting embodiment, each of the cable wires 434 has a length of 2 inches. It is appreciated that length of cable wires in other embodiments may vary.

FIG. 5D illustrates the jumper cable 410 of the lighting system. The jumper cable 410 is configured to extend a length of the strips (or strings), and the jumper cable 410 can further help the lighting system 100 constructed around corners and turning points. Specifically, the jumper cable 410 has a first end 436 with a female connector 438 and a second end 440 with a male connector 442. A cable wire 444 extends between the first and the second ends 436 and 440. In the non-limiting embodiment, the cable wire 444 of the jumper cable 410 is proximately 10 feet. It is appreciated that in some embodiment, length of the cable wire may vary. It if further appreciated that a jumper cable is optional to the lighting system.

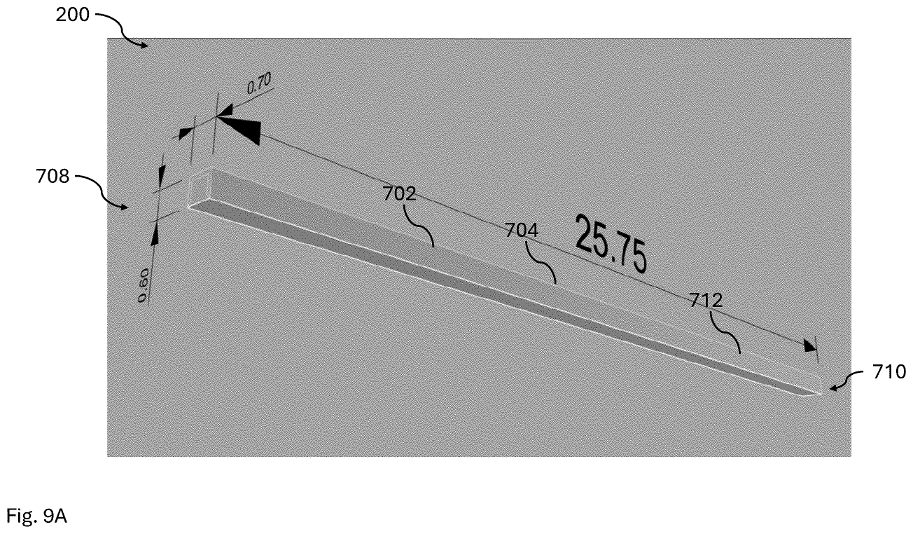

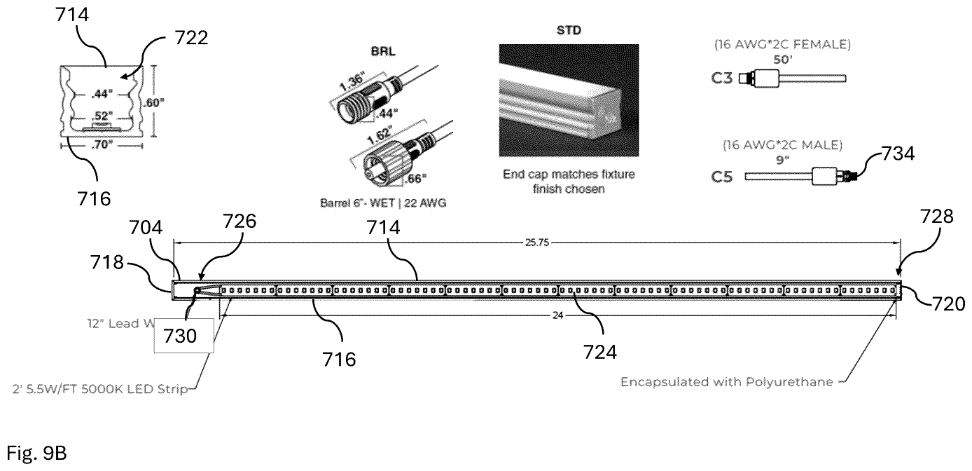

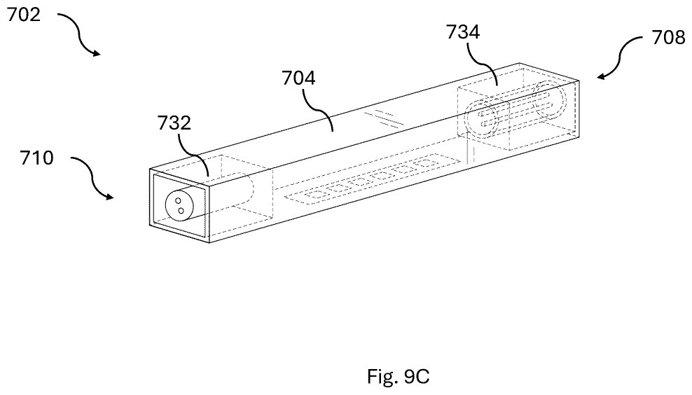

FIG. 5E illustrates a plurality of cable end caps 412 of the lighting system 100 constructed to be inserted into the free end of a string or strip, as shown in FIG. 9B. In the non-limiting embodiment, the cable end caps 412 have a twist lock structure 446 (not shown in the figures). It is appreciated that the caps may also be constructed in various different arrangements to provide quick, efficient and secure connections.

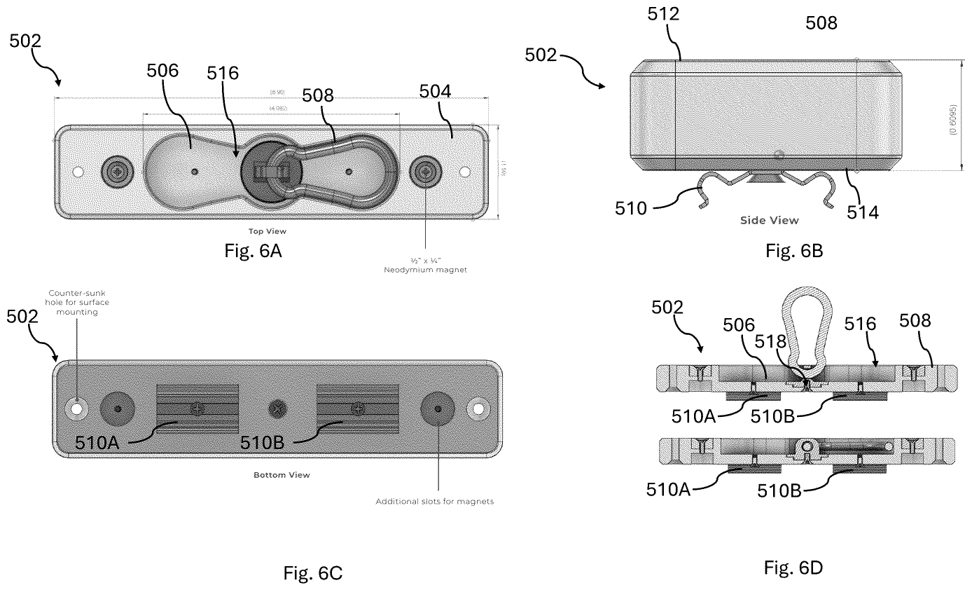

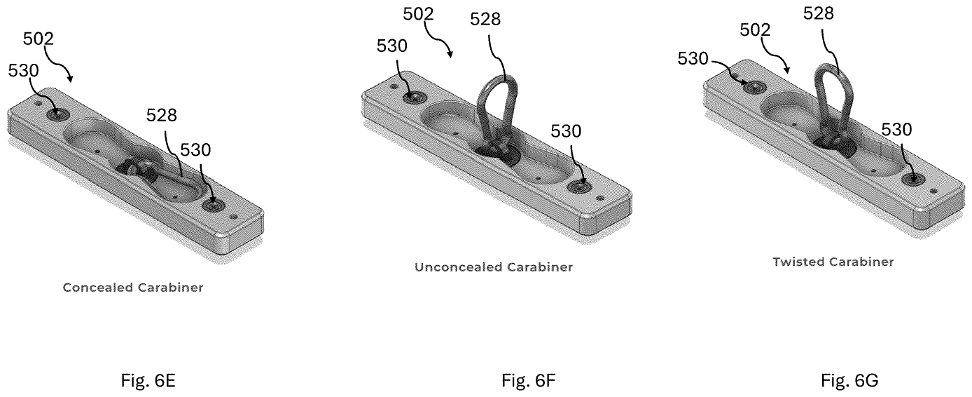

FIGS. 6A-6D provide top, side, bottom, and sectional views of an attachment member in form of a clip 502 of the lighting system 100. The clip 502 has a plate 504 comprising a base 506, an attaching mechanism 508, and one or more strip clips 510. In the non-limiting embodiment, the plate 504 is constructed into a proximal rectangular shape. It is appreciated that in some embodiments, the plate 504 can be constructed in any known three-dimensional shape. As shown in FIGS. 6A and 6D, the plate 504 has a top surface 512 and a bottom surface 514, where the bottom surface 514 is opposite the top surface 512 in a vertical direction. A height of the plate 504 is defined by the distance in the vertical direction between the top surface 512 and the bottom surface 514. The plate 504 further has a cavity 516 that extends from the top surface 512 of the plate 504 to the bottom surface 514. The cavity 516 has a depth proximal equal to the height of the plate 504. The cavity 516 further has a base slot 518 (as shown in FIG. 6D) configured to receive the attaching mechanism 508, the attachment member or mechanism being further configured as a quick-connect mount to secure the clip to various items. Such items include, but are not limited to overhead items such as wires, beams, cable trays, etc. The attachment mechanism is contemplated as being provided in the form of a carabiner, but it is contemplated that various alternatives are provided. For example, the mechanism 508 may be a simple hook. In the non-limiting embodiments, the base slot 518 extends from a first surface 520 of the cavity 516 to a second surface 522 of the cavity 516, where the second surface 522 is vertically below the first surface 520. It is appreciated that the base slot 518 may be constructed in any known three-dimensional shape that is spacious enough to receive the base and allow the base to rotate around a vertical axis within the base slot.

The base 506 comprises a lower section 524 constructed to be inserted into the base slot 518, and an upper section 526 constructed to receive the attaching mechanism 508. In the non-limiting embodiment, the lower section 524 of the base is constructed in a cylindrical volume and is rotatably fitted inside the base slot 518. The upper section 526 of the base is constructed in a proximal semicircular plate with an attaching slot 528 configured to receive the attaching mechanism 508 of the plate 504. It is appreciated that the sizes and shapes of the base may vary in different embodiments.

In the non-limiting embodiment, the base 506 is attached to the plate 504 through a fastening mechanism 530. The base 506 also has a fastener slot 532 extending from the lower section 524 towards the upper section 526, where the fastener slot 532 shares the same axis with the base slot 518, and a fastener 530 may be inserted into the slots 18 and 532 securing the base 506 to the plate 504. The fastener 530 may be selected from a group comprising threaded or unthreaded screws, poles, any faster that can rotatably secure the components, or any combination of the abovementioned mechanism.

In the non-limiting embodiment, the base 506 is rotatably secured to the bottom surface 514 of the plate 504. It is appreciated that in some other embodiments, the base may be affixed to the bottom surface 514 of the plate 504. In the non-limiting embodiment, the upper section 526 of the base is affixed to the lower section 524 of the base. It is appreciated that in some other embodiments, the upper section may be removable from the lower section, and yet in other embodiments, the upper section is rotatably attached to the lower section.

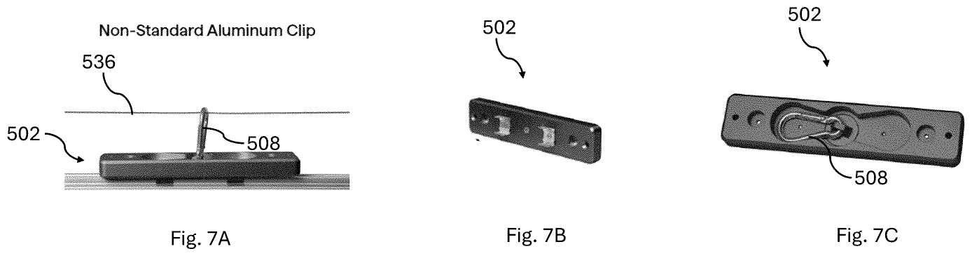

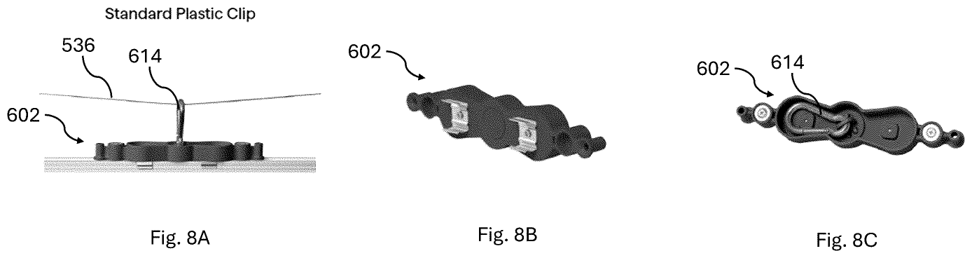

The attaching mechanism 508 is provided to connect the clip 502 to a desired facility. For example, the attaching mechanism 508 may be hooked to a string or a beam of a facility, as shown in FIGS. 7A and 8A. In the non-limiting embodiment, the attaching mechanism 508 is a carabiner with a first end 528 inserted into the attaching slot of the base 508. It is appreciated that in some embodiments, the attaching embodiments may be selected from a group comprising snap hooks, soft shackles, and quick-release rings (for example).

In some embodiments, the plate 504 has one or more counter-sunk holes 530 for surface mounting, where the holes 530 extend through the plate 504 and are configured to receive fasteners such as screws and magnets. The holes 530 may be constructed to different diameters to receive different types of fasteners. The holes 530 are especially useful when there is no hanging or hooking point to receive the attaching mechanism, in which situation the clip 502 has to be mounted to a wall or any other irregular surfaces.

The plate 504 further comprises or more strip clips 510 attached at the bottom surface 514 of the plate 504. The strip clips 510 are provided to attach and secure the light strips to the clip. In the non-limiting embodiment, the strip clips 510 are Terry clips. In some other embodiments, the strip clip can be transistor clips, binder clips, or any other mechanism capable of securing the light strips.

FIGS. 6E-6G illustrate an embodiment wherein the aluminum clip 502 is provided in concealed, unconcealed, and twisted states. When in a first unused or concealed state, as shown in FIG. 6E, a second end 534 of the carabiner 508 is fitted in the cavity 516 resting upon the first surface of the cavity 516. In a second unconcealed state, as shown in FIGS. 6F-6G, the attaching mechanism 508 extrudes away from the base 506. The attaching mechanism or carabiner 508, when in the second unconcealed state, can be arranged in different orientations. For example, in FIG. 6F, the attaching mechanism is perpendicular to a lateral axis of the plate, and in FIG. 6G, the attaching mechanism is parallel to the lateral axis of the plate. In various embodiments, the rotational position of the element 508 about a vertical axis is securable to maintain the device in a desired position.

FIGS. 7A-7C provide a front, bottom, and top view of the aluminum clip 502 of the lighting system 100. As shown in FIG. 8A, in the non-limiting embodiment, the attaching mechanism 508 is attached to a string 536 and hanging the clip 502 with the attached light strip 536. It is appreciated that in other embodiments, the attaching mechanism may be concealed inside the cavity, as shown in FIG. 7C, and the clip may be mounted to a desired surface with the top surface of the plate contacting the desired surface (not shown in figures).

FIGS. 8A-8C provide a front, bottom, and top view of a plastic clip 602 of the lighting system 100. The working principle and structural design of the plastic clip 602 are similar to the above-mentioned aluminum clip 502. In the non-limiting embodiment, unlike the aluminum clip being constructed with a proximal rectangular prism plate, the plastic clip 602 has a plate 604 with irregular outline. Specifically, the plastic clip 602 has a bottom surface 606, and a wall 608 defining a cavity 610 configured to receive a base 612 and an attaching mechanism 614. The plastic clip 602 can also be hooked or hung to strings and ropes or attached to a mounting surface with fasteners. It should be recognized that mounting clips of the present disclosure may comprise various materials and are not limited to plastic and/or aluminum.

FIGS. 9A-9C illustrate a strip 702 of a lighting system 200, in accordance with one or more embodiments of the present application. In the non-limiting embodiment, the strip 702 has an outer shell 704 constructed into a rectangular envelope. The outer shell 704 is constructed in at least partially transparent materials for illuminating purposes. The outer shell 704 has a first end 708 and a second end 710 as opposed to the first end 708. The first and second ends 708 and 710 are proximate rectangular shape with a width of proximate 0.7 inches in the lateral direction and a height of 0.5 inches in the vertical direction. A plurality of sidewalls 712 extends in the longitudinal direction between the first and second ends 708 and 710. The sidewalls 712 have a length of approximately 25.75 inches. It is appreciated that in other embodiments, the dimensions and shapes of the strip 702 may vary.

In the non-limiting embodiment, the plurality of sidewalls 712 further has a top wall 714, a bottom wall 716, a front wall 718, and a back wall 720. Each of the plurality of sidewalls 712 has an interior surface. The interior surfaces of the sidewalls 712 define a cavity 722, as shown in FIG. 9B, of the outer shell 704. Each of the front and back walls of the outer shell 704 has an uneven interior surface. As a result, in the non-limiting embodiment, the cavity 722 of the strip 702 has a minimum width of 0.44 inches and a maximum width of 0.52 inches.

The strip 702 of the lighting system 700 further has an LED strip 724 fitted inside the outer shell 704. The LED strip 724 has a first end 726 placed proximate to the first end 708 of the outer shell 704, and the first end 708 of the outer shell 704 may be encapsulated with polyurethane. The LED strip 724 further has a second end 728 opposite to the first end 726 and has a lead wire 730. The second end 728 of the LED strip 724 is placed proximate to the second end 710 of the outer shell 704. The LED strip 724 has a length defined by the distance between the first and second ends 726 and 728. In the non-limiting embodiments, the LED strip 724 has a length of 12 inches, allowing the lead wire 730 to be close to the second end 710 of the outer shell 704 without touching the second end 710 of the outer shell 704. It is appreciated that the length of the LED strip 724 may vary in different embodiments.

The strip 702 further has two connectors 730, as shown in FIG. 9C, placed at the first and second ends 708 and 710 of the outer shell 704. Specifically, one end has a female connector 732, and one end has a male connector 734. In the non-limiting embodiment, the connectors are built-in waterproof connectors. It is appreciated that in some other embodiments, the connector may or may not be waterproof, and the connectors may be provided separately from the outer shell.

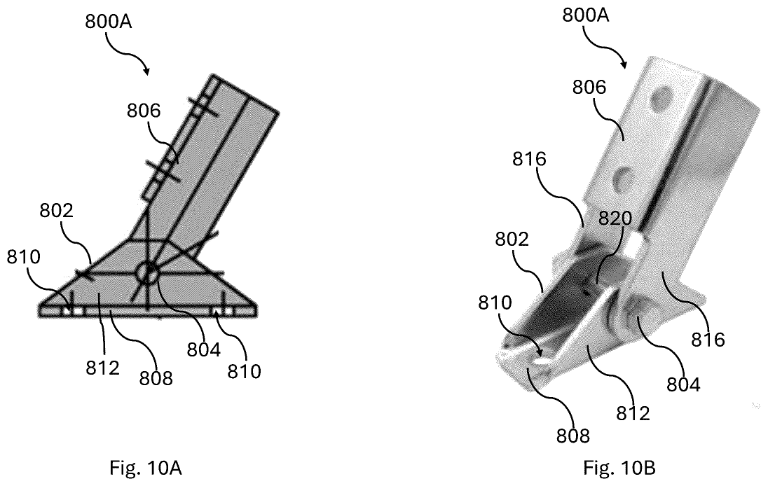

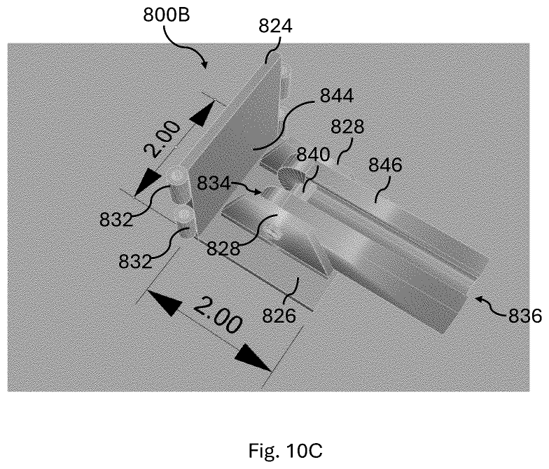

FIGS. 10A-10B provide right and perspective view of a bracket 800A of the lighting system 200. The bracket 800A has a base 802A, a connecting mechanism 804A, and a strip receiver 806A. In the non-limiting embodiment, the base 802A of the bracket 800A has a bottom plate 808A. The bottom plate 808A has one or more slots 810A constructed to receive fasteners to secure the bracket 800A to a desired surface. The bracket 800A also has two proximate triangular side plates 812A placed on each side of the bottom plate 808A. Each of the side plates 812A has a connecting slot 814A. The strip receiver 806A has two legs 816A, and each leg 816A has a connecting slot 818A. In the non-limiting embodiment, when placed together, the connecting slots 818A become co-axial slots, and the strip receiver 806A is pivotably connected to the base 802A of the bracket 800A with a connecting rod 820A inserted through all connecting slots 818A. It is appreciated that in some embodiments, the connecting slots may be co-axial, and one or more connecting rods or fasteners may be provided to connect the strip receiver to the base of the bracket. The strip receiver 806A has a sleeve 822A constructed in a rectangular prism with a cavity to receive a strip 702. It is appreciated that in other embodiments, the strip receiver 806A may be constructed in any other known three-dimensional volume.

FIG. 10C illustrates another embodiment of a bracket 800B. In some embodiments, the base 844 of the bracket 800 has a back plate 824, as shown in FIG. 10C, in addition to a bottom plate 826. In the non-limiting embodiment, the back plate 824 is perpendicular to the bottom plate 826, and the bottom plate 826 further has two side plates 828 with slots 830 that are configured to be connected to the strip receiver 846. The back plate 824 of the bracket 800 has one or more connecting mechanisms 832 configured to be connected to other brackets. In the non-limiting embodiment, the connecting mechanisms are constructed in cylindrical volume with a hollow center configured to receive fasteners. Each side of the back plates has two connecting mechanisms.

The strip receiver 846 has a first end 834 and a second end 836 opposite to the first end 834. The first end 834 of the receiver 806 is pivotally attached to the side plates 828 of the base 844 of the bracket 800 through the two connecting slots 830. The second end 836 of the receiver 806 can freely rotate, allowing the receiver 806 to form an angle from proximate 0 degrees to proximate 180 degrees relative to the bottom plate 826 of the bracket 800. The strip receiver 846 further has a slot 838 extending from the first end 834 to the second end 836 configured to receive a strip. It is appreciated that in some embodiments, the strip receiver may be constructed with a fixed angle.

In the non-limiting embodiment, a fastener/rod 840 is provided to secure the adjustable strip receiver 806 at a desired angle. For example, in some embodiments the fastener 840 may include a hex bolt and a hex nut. The hex boltis inserted into the slots 830 of the strip receiver 806 and the base 802 and is tightened by screwing the nut to the bolt. When the connection of the bolt and nut is tightened, the hexagonal head of the bolt and the nut compress the legs 816 of the receiver 806 and the sidewalls of the base 802 together from opposite directions, creating a friction force on the contacting surfaces. The friction force further secures the strip receiver 806 at a desired angle and prevents the strip receiver from dropping. It is appreciated that in some embodiment, the fastener may be any mechanism that can secure and tighten the receiver to the base. In some embodiments, a supporting mechanism, for example, a securing pin or a supporting rod, may be provided to secure the strip receiver at a desired angle.

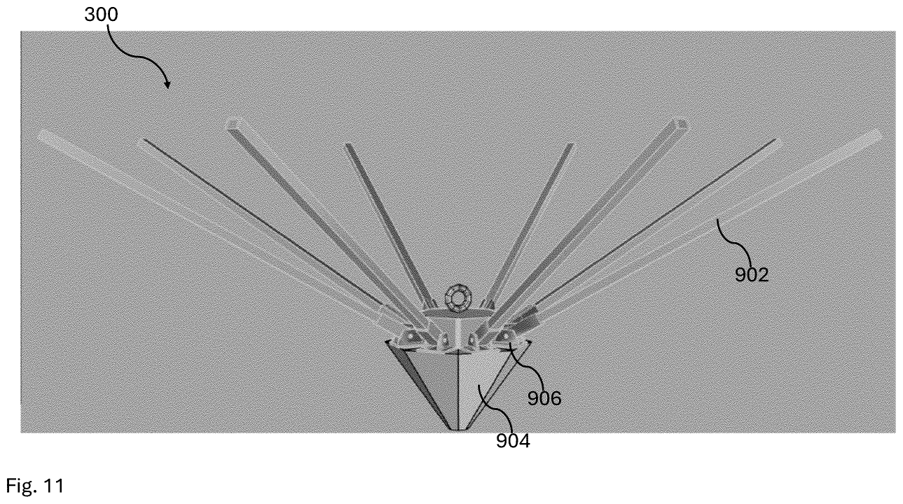

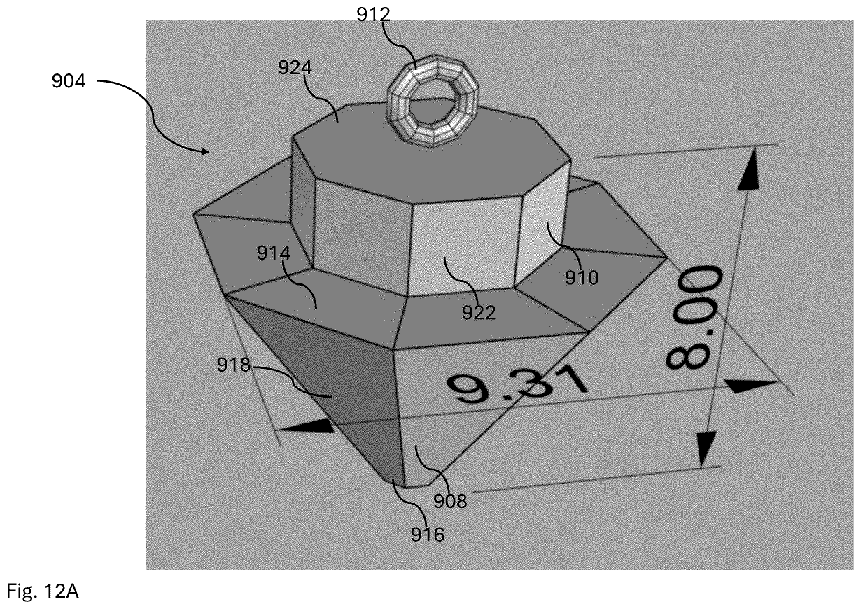

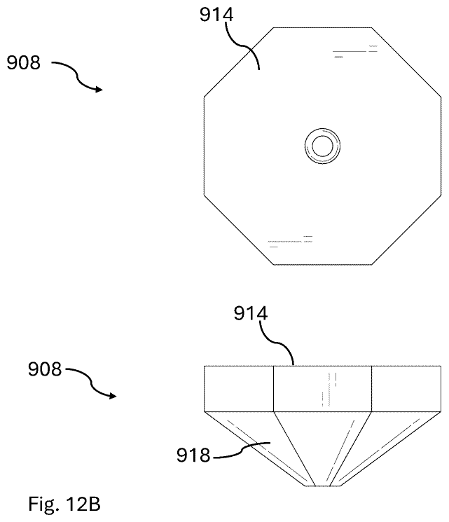

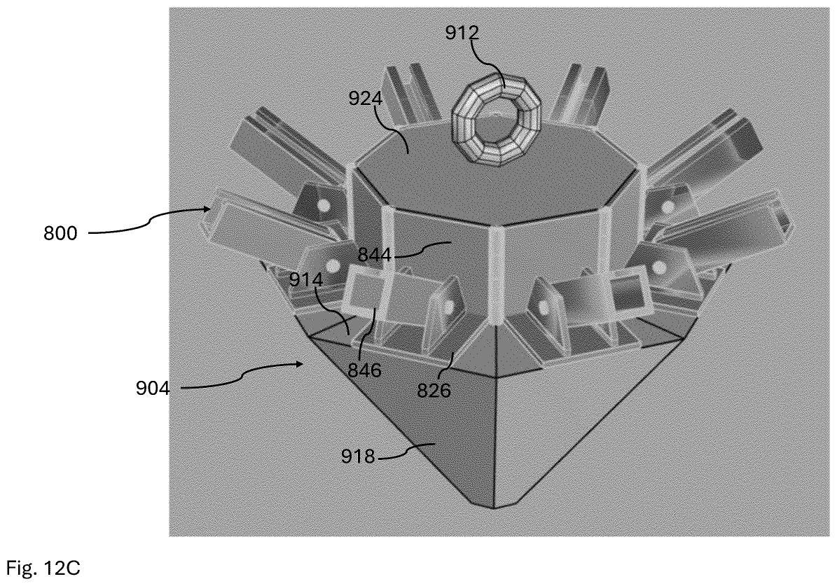

FIG. 11 illustrates a modular lighting system 300 constructed in a particular shape. In the non-limiting embodiment, the modular lighting system 300 is constructed with a plurality of strips 902, a base 904, and a plurality of brackets 906. The plurality of brackets 906 and strips 902 are arranged around the circumference of the base 904, extending away from the base 904.

FIGS. 12A-12C illustrate the base 904 of the modular lighting system 300 without the plurality of the brackets 906. In the non-limiting embodiment, the base 904 has a lower section 908, an upper section 910, and a ring 912. The lower section 908 has an octagon top surface 914 and a round bottom end 916. The lower section 908 further has a plurality of side surfaces 918 extending from the circumference of the top surface 914 to the round bottom end 916. In the non-limiting embodiment, the plurality of side surfaces 918 has eight side surfaces. It is appreciated that in some embodiments, the number of side surfaces and the shape of the top and bottom surfaces may vary. In the non-liming embodiments, the octagon top surfaces 914 have a diameter of 9.31 inches. It is appreciated that in some embodiments, the dimensions of the top surface may vary.

The upper section 910 of the star base 904 has a bottom surface 920 (not shown in Figures) in contact with and parallel to the top surface 914 of the lower section 908. A plurality of sidewalls 922 of the upper section 910 extends from the bottom surface 920 along the vertical axis towards a top surface 924 of the upper section 910, forming a column. The sidewalls 922 are further perpendicular to the top surface 914 of the lower section 908. In the non-limiting embodiment, the bottom and top surfaces 920 and 924 of the upper section 910 are proximate octagons with a diameter smaller than the diameter of the top surface 914 of the lower section 908 of the star base 904. The upper section 910 in the non-limiting embodiment is an octagonal column with eight sidewalls 922, and the total height from the top surface 924 of the upper section 910 to the bottom end 916 of the lower section 908 is approximately 8 inches. It is appreciated that in some embodiments, the shape and dimension of the upper section may vary.

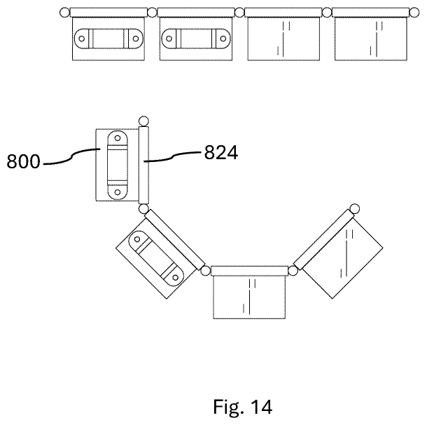

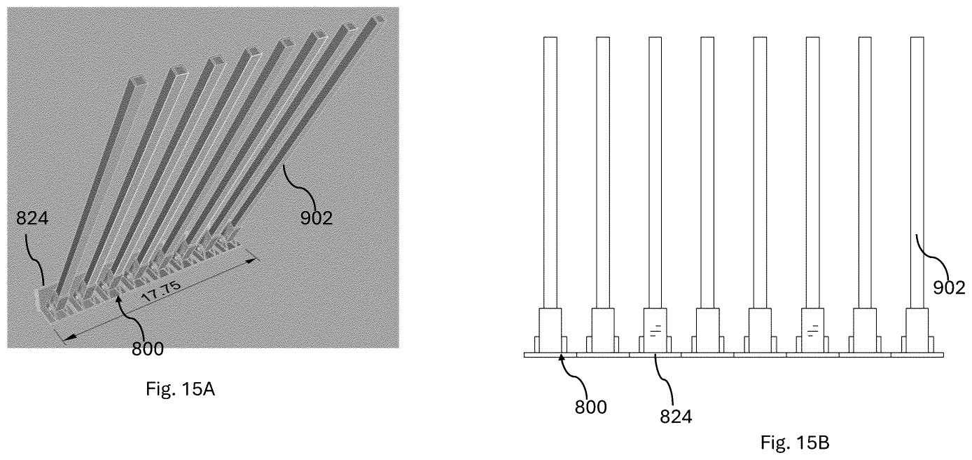

Together, the upper surface 914 of the lower section 908 and the sidewalls of the upper section 910 defines a circumferential platform configured to receive strip brackets 800, as shown in FIG. 12C. Specifically, in the non-limiting embodiments, a plurality of brackets 800 (as shown in FIG. 10C) is attached to the star base 904. Each of the plurality of the bracket 800 has its bottom plate connected and parallel to the top surface 914 of the lower section 908 of the star base 904; and has its back plate 844 parallel to and in contact with the sidewalls 922 of the upper section of the lower base. Furthermore, the plurality of brackets 800 is each connected to its abutted brackets, as shown in FIG. 14, with fasteners inserted into the side receivers of the brackets, forming a closed loop defined by the back plates 824 of the plurality of the brackets. The closed loop further surrounds the upper section of the star base. In the non-liming embodiment, In the non-limiting embodiments, the star base 904 further has the ring 912 attached to the top surface 920 of the upper section 910.

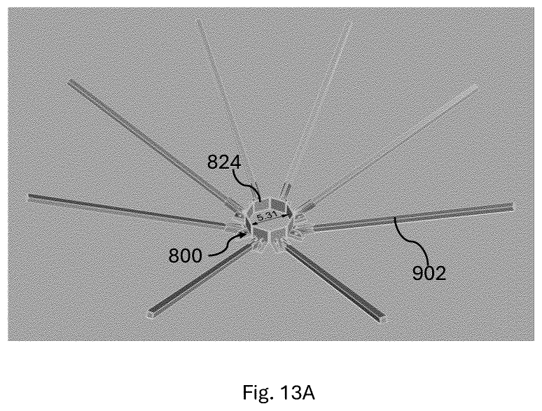

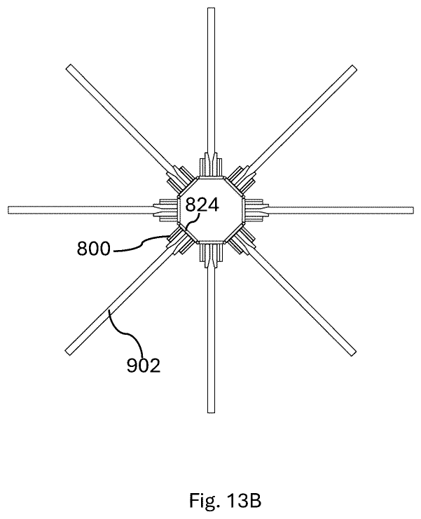

FIGS. 13A-13B illustrate the modular lighting system 800 converted into another desired shape devoid of a base and wherein the lighting elements extend radially away from a center point. As discussed, the plurality of the brackets 800 may be connected to each other forming into a closed loop, and the back plates 824 of the brackets define the octagonal ring, as shown in FIG. 14. FIGS. 15A-15B illustrate the modular lighting system 800 converted into yet another shape (the third shape). with the plurality of the brackets 800 connected to its abutted brackets. Instead of forming a close loop like in a star or crown configuration, in a flag configuration, the brackets are connected and aligned on a straight line. In a case where the strip receivers are adjusted to a same angle, the plurality of the strips are parallel to each other forming a “flag”.

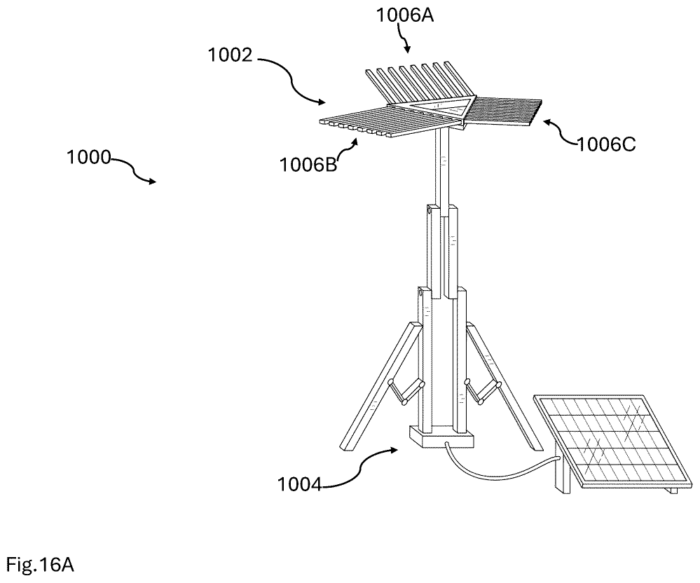

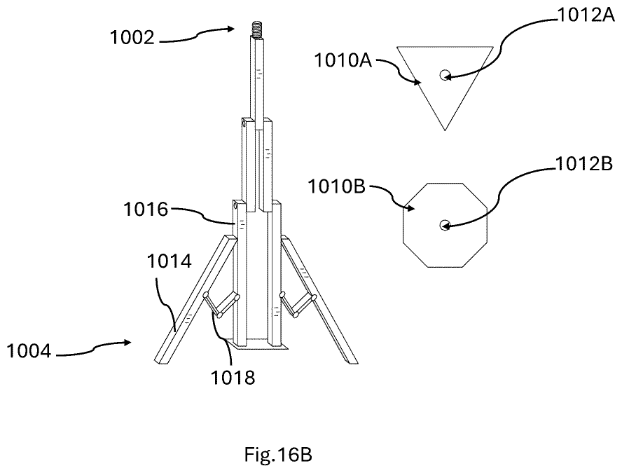

FIGS. 16A-16B illustrate the modular lighting system 1000 with multiple “flag” arrangements in the third shape and with a stand configured to elevate the lighting components. In the non-limiting embodiment, the stand 1000 has a first end 1002 and a second 1004 end opposite to the first end 1002. The first end 1002 is configured to attach one or more of the lighting components 1006. Here, the lighting components 1006 include three “flags” with the brackets 800 of the lighting components arranged into a proximate triangular shape. In some other embodiments, the lighting components may be in other configurations, including but not limited to the crown and the star configurations. In yet other embodiments, the lighting component may include any number of brackets and strips. The second end of the flat is connected to a power source. In the non-limiting embodiment, the power supply is a battery. The system 1000 is contemplated as being powered, at least partially, by a photovoltaic member such that the system is suitable for use in various settings or environments that lack a dedicated power source. For example, the system 1000 is contemplated as being deployable in a construction setting and/or various “off-grid” settings.

Specifically, as shown in FIG. 16B, the first end 1002 of the stand has a fastener 1008 (for example, a threaded bolt). In the non-limiting embodiment, each flag lighting component is attached to a side of a triangular flag base 1010. The flag base 1010 has a slot 1012 in its central points, and the flag base 1010 can be secured to the first end 1002 of the stand by inserting a fastener through the slots 1012 of the flag base 1010 and the stand 1002. The stand 1000 further has one or more supporting rod 1014 connected to a main rod 1016 via extendable connector 1018.

In all configurations, including the abovementioned star, crown, and flagpole shapes, each one of the plurality of the strips is inserted into one of the plurality of the brackets'strip receivers, and the strips can be adjusted up and down, as shown in FIG. 13B, with the strip receiver being pivoted to different angles from the base of the brackets.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

What is claimed is:

1-2. (canceled)

3. A lighting element attachment system, the system comprising:
a base member comprising a first surface and a second surface, and wherein the base member is operable to be connected to one or more securing members proximal to the first surface and the second surface is operable to receive one or more lighting elements;
a rotatable attachment member extending from and in communication with the first surface;
wherein the first surface comprises at least one of a cavity and a recess to selectively receive the rotatable attachment member at least when the rotatable attachment member is not in a position of use;
wherein the second surface comprises a resilient clip that is operable to selectively receive a lighting element.

4. The attachment system of claim 3, wherein the rotatable attachment member comprises a carabiner.

5. The attachment system of claim 3, wherein the rotatable attachment member is rotatable about a first axis to convert the rotatable attachment between a position of use and a position of non-use, and the wherein the rotatable attachment member is further rotatable about a second axis.

6. The attachment system of claim 3, wherein the at least one of a cavity and a recess is shaped to correspond to the shape of the rotatable attachment member.

7. The attachment system of claim 3, further comprising at least one of a string and a cable and wherein the rotatable attachment member is secured to the at least one of a string and a cable at least in a position of use.

8. The attachment system of claim 3, further comprising a track lighting element secured to the resilient clip.

9. The attachment system of claim 3, wherein the system comprises at least two resilient clips extending from the second surface.

10. The attachment system of claim 8, wherein the track lighting element comprises a battery-powered track lighting element.

11. A lighting element attachment system, the system comprising:
a base member comprising a first surface and a second surface, and wherein the base member is operable to receive and support one or more lighting elements;
at least one of a cavity and a recess provided in the first surface to selectively receive a rotatable attachment member;
wherein the second surface comprises a resilient clip that is operable to selectively receive a lighting element.

12. The attachment system of claim 11, wherein the rotatable attachment member comprises a carabiner with a gate.

13. The attachment system of claim 11, wherein the rotatable attachment member is rotatable about a first axis to convert the rotatable attachment between a position of use and a position of non-use, and the wherein the rotatable attachment member is further rotatable about a second axis.

14. The attachment system of claim 13, wherein the first axis is orthogonal to the second axis.

15. The attachment system of claim 11, wherein the at least one of a cavity and a recess is shaped to correspond to the shape of the rotatable attachment member.

16. The attachment system of claim 11, further comprising at least one of a string and a cable and wherein the rotatable attachment member is secured to the at least one of a string and a cable at least in a position of use.

17. The attachment system of claim 11, further comprising a lighting element secured to the resilient clip.

18. The attachment system of claim 11, wherein the system comprises at least two resilient clips extending from the second surface.

19. The attachment system of claim 17, wherein the lighting element comprises a battery-powered track lighting element.

20. A method of mounting an overhead lighting element, the method comprising:
providing an attachment mechanism comprising a base member having a first surface and a second surface, the base member comprising at least one of a cavity and a recess provided in the first surface to selectively receive a rotatable attachment member, and the second surface comprising a resilient clip that is operable to selectively receive a lighting element;
mounting the attachment mechanism to a preexisting overhead structure by securing the rotatable attachment member to the preexisting overhead structure; and
securing at least one lighting element to the resilient clip.

21. The method of claim 20, wherein the lighting element comprises a battery-powered lighting element.

22. The method of claim 20, wherein the rotatable attachment member comprises a clip and the preexisting overhead structure comprises at least one of a cable, a wire and a string.
